(19) United States
(12) Patent Application Publication
(10) Pub. No.: US 2026/0251501 A1
(43) Pub. Date: Aug. 27, 2026

(54) SYSTEMS AND METHODS FOR MONITORING ILLUMINATION CONDITIONS PRODUCED BY LIGHT SOURCES

(71) Applicant: SOLLUM TECHNOLOGIES INC., Montréal (CA)

(72) Inventors: François R.-MOISAN, Montréal (CA); Jacques POIRIER, Montréal (CA); Alan Leandro GARCIA, Montréal (CA); Maxime CIRCE, Montréal (CA); Pierre GAGNÉ, Montréal (CA); Émile BERGERON, Montréal (CA)

(21) Appl. No.: 19/552,277

(22) Filed: Feb. 27, 2026

Related U.S. Application Data
(60) Provisional application No. 63/764,089, filed on Feb. 27, 2025.

(51) Int. Cl. G01J 3/36; G01J 3/02; G01J 3/28; G01J 3/44

(52) U.S. Cl. CPC G01J 3/36; G01J 3/0202; G01J 3/0297; G01J 3/2803; G01J 3/4412; G01J 2003/4418

(57) ABSTRACT

There are provided techniques for monitoring illumination conditions produced by light sources. The techniques include measuring at least one optical property of the illumination conditions with at least two sensors; obtaining information associated with the at least one optical property measured by the at least two sensors; and comparing the information to determine a presence or an absence of unexpected data, such that: in the presence of unexpected data, determining an event potentially attributable to the presence of unexpected data and providing a correction factor to the at least one optical property measured by the at least two sensors to obtain at least one corrected optical property representative of actual illumination conditions; and in the absence of unexpected data, validating that the at least one optical property measured by the at least two sensors is representative of the actual illumination conditions.

### TECHNICAL FIELD

The technical field generally relates to indoor lighting, and more particularly concerns systems and methods for monitoring illumination conditions.

### BACKGROUND

There remains a need for a method or system that can provide improvements in methods and systems for monitoring illumination conditions.

### SUMMARY

The present techniques relate to techniques for managing, mitigating or even eliminating challenges associated with calibration drift, spectral response variability, positioning, orientation and maintenance requirements of sensors used for monitoring illumination conditions produced by light sources.

In accordance with one aspect, there is provided a system for monitoring illumination conditions produced by light sources, the system including an elongated frame; at least two sensors mechanically connected to the elongated frame and oriented towards the light sources, the at least two sensors being adapted to measure at least one optical property of the illumination conditions; and a processor operatively connected to the at least two sensors, the processor being configured to: obtain information associated with the at least one optical property measured by the at least two sensors; compare the information to determine a presence or an absence of unexpected data, such that: in the presence of unexpected data, the processor is configured to determine an event potentially attributable to the presence of unexpected data and provide a correction factor to the at least one optical property measured by the at least two sensors to obtain at least one corrected optical property representative of actual illumination conditions; and in the absence of unexpected data, the processor is configured to validate that the at least one optical property measured by the at least two sensors is representative of the actual illumination conditions.

In some embodiments, the system further includes a panel extending over the at least two sensors.

In some embodiments, the panel is made of diffused glass.

In some embodiments, the system further includes a levelling-assistance mechanism operatively connected to at least one of the elongated frame and the at least two sensors, the levelling-assistance mechanism being configured to control a position or an orientation of at least one of the elongated frame and the at least two sensors with respect to the light sources.

In some embodiments, the levelling-assistance mechanism includes an accelerometer and/or a gyroscope.

In some embodiments, the levelling-assistance mechanism includes a feedback loop configured to detect and/or monitor the position or orientation of the elongated frame and/or the at least two sensors and provide an indication associated therewith.

In some embodiments, the system further includes a calibration mechanism, the calibration mechanism including at least one calibration emitter, the at least one calibration emitter being configured to emit a reference beam in a non-continuous regime, the reference beam having reference properties, the calibration mechanism being configured to compare the reference properties measured by the at least two sensors with calibration data representative of expected reference properties, and, upon identification of a difference between the reference properties and the calibration data, adjust the correction factor accordingly.

In some embodiments, the non-continuous regime includes emitting the reference beam at a predetermined interval for a predetermined duration.

In some embodiments, the reference beam is emitted when the light sources are closed.

In some embodiments, each of the at least two sensors is a spectral sensor configured to detect wavelengths in a range extending from about 380 nm to about 1000 nm.

In some embodiments, the at least one optical property includes a spectrum power distribution (SPD) of the illumination conditions.

In some embodiments, the at least two sensors is an array of sensors evenly distributed between two extremities of the elongated frame.

In accordance with one aspect, there is provided a method for monitoring illumination conditions produced by light sources, the method including measuring at least one optical property of the illumination conditions with at least two sensors; obtaining information associated with the at least one optical property measured by the at least two sensors; and comparing the information to determine a presence or an absence of unexpected data, such that: in the presence of unexpected data, determining an event potentially attributable to the presence of unexpected data and providing a correction factor to the at least one optical property measured by the at least two sensors to obtain at least one corrected optical property representative of actual illumination conditions; and in the absence of unexpected data, validating that the at least one optical property measured by the at least two sensors is representative of the actual illumination conditions.

In some embodiments, the method includes controlling, with a levelling-assistance mechanism, a position or an orientation of at least one of the elongated frame and the at least two sensors with respect to the light sources.

In some embodiments, the method includes calibrating the at least two sensors with a calibration mechanism, the calibration mechanism including at least one calibration emitter, the at least one calibration emitter being configured to emit a reference beam in a non-continuous regime, the reference beam having reference properties, the calibration mechanism being configured to compare the reference properties measured by the at least two sensors with calibration data representative of expected reference properties, and, upon identification of a difference between the reference properties and the calibration data, adjust the correction factor accordingly.

Other features and advantages of the method and system described herein will be better understood upon a reading of preferred embodiments thereof with reference to the appended drawings. Although specific features described in the above summary and in the detailed description below may be described with respect to specific embodiments or aspects, it should be noted that these specific features can be combined with one another unless stated otherwise.

### BRIEF DESCRIPTION OF THE DRAWINGS

FIGS. 1 to 7 illustrate various aspects, features, and implementations of, or related to, the present techniques.

### DETAILED DESCRIPTION

In the present description, similar features in the drawings have been given similar reference numerals. To avoid cluttering certain figures, some elements may not have been indicated if they were already identified in a preceding figure. It should also be understood that the elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. More particularly, it will be understood that such spatially relative terms are intended to encompass different orientations in the use or operation of the present embodiments, in addition to the orientations exemplified in the figures.

The terms “a”, “an” and “one” are defined herein to mean “at least one”, that is, these terms do not exclude a plural number of items, unless stated otherwise.

Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements may be acoustical, mechanical, optical, electrical, thermal, logical, or any combinations thereof.

The terms “match”, “matching” and “matched” are intended to refer herein to a condition in which two elements are either the same or within some predetermined tolerance of each other. That is, these terms are meant to encompass not only “exactly” or “identically” matching the two elements but also “substantially”, “approximately” or “subjectively” matching the two elements, as well as providing a higher or best match among a plurality of matching possibilities.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

It should be noted that, in the context of the current disclosure, the expression “plants or crops” may encompass a broad variety of multicellular organisms, including photosynthetic eukaryotes. Non limitative examples of plants or crops are seedlings, ornamental crops, ornamental plants, plugs, liners, fruits, small fruits, vegetables, leafy greens, herbs, young plants, high-value crops, and many others. The plants or crops may be produced for human food, non-human food or non-food applications. The growing process of the plants or crops generally includes a plurality of subsequent plant growth stages, such as, for example, seed germination (or “sprout”), seedling, vegetative, bud stage (or “budding”), flowering and ripening. It should be understood that, in the present description, the plants or crops can be at any one of the plant growth stages or at a transition between any two subsequent growth stages.

The expression “horticultural light”, synonyms and derivatives thereof may be used throughout the present disclosure, and refers to the use of optical techniques, systems, and methods for assisting, maintaining, stimulating and/or optimizing plants or crops growth. The horticultural light may irradiate or illuminate the plants or crops during any one of the plant growth stages. The horticultural light, which is the light generated by the horticultural lighting apparatus, may be produced or generated using an artificial light source or similar devices, apparatuses, and systems. Non-limiting examples of artificial light sources include incandescent light sources, fluorescent light sources, high-intensity discharge (HID) light sources such as mercury vapor, metal halide (MH), high-pressure sodium (HPS) and low-pressure sodium (LPS) light sources, solid-state light sources including LED light sources, and laser sources. The horticultural light is associated with an illumination spectrum or profile. In some implementations, the horticultural light produced by the horticultural lighting apparatus has a profile substantially similar to light reaching the crop or plant. The expression “illumination spectrum” is used to broadly refer to the spectral power distribution of an illumination. The illumination spectrum can represent the distribution of power radiated per unit area and per unit wavelength or frequency over a spectral region of the electromagnetic spectrum. It should be noted that using horticultural light may be used to irradiate or illuminate plants or crops growing in a horticultural structure providing regulated climatic conditions to the plants or crops. Nonlimitative examples of horticultural structures include greenhouse, glasshouse and hothouse.

In the present description, the terms “light” and “optical”, and variants and derivatives thereof, are used to refer to radiation in any appropriate region of the electromagnetic spectrum. The terms “light” and “optical” are therefore not limited to visible light, but can also include, without being limited to, the infrared and ultraviolet regions. For example, in some implementations, the present techniques can be used with electromagnetic signals having wavelengths ranging from about 250 nm to about 2500 nm. However, this range is provided for illustrative purposes only and some implementations of the present techniques may operate outside this range. Also, the skilled person will appreciate that the definition of the ultraviolet, visible and infrared ranges in terms of spectral ranges, as well as the dividing lines between them, can vary depending on the technical field or the definitions under consideration, and are not meant to limit the scope of applications of the present techniques.

The expressions “natural light” or “natural light conditions” generally refer to light having spectral characteristics corresponding or similar to those of sunlight, moonlight or starlight. The spectral profile of natural light, particularly sunlight, varies as a function of geographic location, time of day, time of year, weather, cloud coverage, and several other factors. Several standards are known in the art to provide a spectral reference for natural light. For example, the Commission internationale de l'éclairage (CIE) has established the D series of well-defined daylight standard illuminants representing natural light under different conditions. One well-known standard is CIE Standard Illuminant D65, which is a daylight illuminant that intends to represent the average midday light in Western or Northern Europe. Other examples of CIE Standard Illuminants for daylight include the D50, D55, and D75 standard illuminants. Sunlight, which refers to the total spectrum of electromagnetic radiation emitted by the Sun and reaching the Earth, has a broad spectral range including ultraviolet radiation, visible light, and infrared radiation. Accordingly, standard illuminants extend within the solar radiation spectrum. For example, Standard Illuminant D65 extends from 300 nm to 830 nm. Non-limiting examples of natural light sources include sunlight, moonlight, starlight, twilight, lightning, and firelight.

In the present description, the term “solid-state light emitter” refers to any light-emitting device that converts electrical energy into electromagnetic radiation through the recombination of electronic carriers (i.e., electrons and holes) in a light emitting layer or region. The emitting layer or region can include, but is not limited to, silicon, silicon carbide, gallium nitride and/or other semiconductor materials, and may or may not include a substrate such as sapphire, silicon, silicon carbide and/or other microelectronic substrates. The solid-state light emitters can include both inorganic and organic light emitters, many of which are known to the skilled person and need not be described in detail herein. Non-limiting examples of types of solid-state light emitters include semiconductor light-emitting diodes (LEDs), semiconductor laser diodes, vertical cavity surface emitting lasers (VCSELs), other semiconductor light emitting devices or lamps, organic light-emitting diodes (OLEDs), and polymer light-emitting diode (PLEDs).

The expression “lighting scenario” is understood to refer to the generation of light, such as for illuminating purposes, according to predetermined optical characteristics (e.g., spectral content, intensity, polarization) that vary or evolve over time during a given time period. The optical characteristics of the generated light may correspond to or emulate those of natural lighting conditions. The natural light may emulate or be inspired from the actual light conditions experienced at a specific geographical location, date and time. It is appreciated that devising lighting scenarios that combine natural light conditions corresponding to different geographical locations is possible in some applications (e.g., a scenario could be build using sunrise, midday and sunset conditions corresponding to three distinct locations on Earth, at the same or different dates). In other embodiments, however, the natural light conditions may be different from real life conditions on Earth. By way of example, the spectrum of natural light generated according to the method described herein may differ from an actual spectral content of sunlight due to the absence of spectral components which are undesired or unnecessary in a given application context, or conversely by the enhancement or addition of wavelengths then are considered advantageous or required. The present techniques may rely on the use of solid-state light emitters. The solid-state light emitters can be driven to produce the lighting scenario using sets of control parameters. It should be noted that a plurality of lighting scenarios may be combined to collectively determine a “recipe” or a “recipe bundle”. The recipe or the recipe bundle refers to a sequence of lighting scenarios.

In some embodiments, the lighting scenario may emulate lighting conditions over the course of a day, from dawn to dusk, or over a portion of a day. Indeed, the spectral contents of light reaching a particular location on earth from the Sun is not constant as the day progress. In some instances, it can be customary to characterize natural light according to its Correlated Color Temperature (CCT) value, expressed in Kelvin (K). By convention, the CCT is defined by the CIE as “the temperature of the Planckian radiator whose perceived color most closely resembles that of a given stimulus at the same brightness and under specified viewing conditions” (CIE/IEC 17.4:1987, International Lighting Vocabulary). Lower CCT values correspond to “warmer” light. Hence, a day with a clear blue sky can begin at dawn with light in a warm CCT spectrum range, such as between 1500K and 3000K, then progress to about 5000K to 7500K at mid-day and return to the 1500K to 3000K range towards dusk. In horticultural or agricultural applications, the light conditions in a region of the world from which a cultivated produce originates or where this produce is known to thrive can be emulated (e.g., growing tomatoes using light conditions from a sunny day in June in Tuscany). In other examples, the lighting conditions may be adapted in view of observations or discoveries regarding optimal or enhanced lighting conditions for growing a given agricultural output, such as for example to follow the McCree Curve, which represents the average photosynthetic response of plants to light energy.

Optical sensors (sometimes referred to as “detectors”) can be used to measure one or more optical properties of light, such as, for example and without being limitative, power, intensity and spectral components. Portable optical sensors are a subclass of optical sensors which can be used in diverse environments, including outdoor environments and indoor environments. Portable optical sensors can be used in a broad variety of applications, such as agriculture (e.g., greenhouse or field monitoring), indoor lighting design, photography, environmental monitoring, healthcare (e.g., phototherapy), consumer electronics (e.g., smartphones), educational laboratories, to name a few. Optical measurements in these contexts can potentially allow optimizing plant growth conditions, ensuring proper exposure in photography, monitoring light pollution's impact on ecosystems, regulating light therapy in healthcare, adjusting screen brightness in devices, and facilitating hands-on learning in educational settings. Fixed optical sensors are often used in various environments such as, for example and without being limitative, street lighting, building automation, industrial facilities, parking lots, sports stadiums, public spaces, laboratories, and aquatic environments. Using fixed optical sensors in these contexts can potentially contribute to energy savings, safety, and productivity by continuously monitoring ambient light levels and adjusting artificial lighting accordingly. Fixed optical sensors can be connected to various systems, such as, for example, lighting control systems, building automation systems (BAS), smart lighting systems, environmental monitoring systems, control panels, and wireless networks/IoT platforms. These connections allow for a centralized monitoring and control of lighting conditions, optimizing energy efficiency, occupant comfort, and operational requirements in different environments.

The quality and reliability of the measurements produced by existing optical sensors are sometimes questionable. Nonlimitative examples of drawbacks associated with existing optical sensors include calibration drift, spectral response variability, cross-sensitivity, sensitivity to positioning and/or orientation, and maintenance requirements. Each of these drawbacks will be briefly discussed in the following paragraph.

Optical sensors may drift out of calibration over time, which leads to inaccurate measurements. This drawback is referred to as “calibration drift”. Calibration drift can be caused by a plurality of factors such as, for example, environmental changes, sensor aging, and degradation of components, to name a few. A regular calibration is typically necessary to maintain the accuracy of measurements produced by optical sensors.

Now turning to the spectral response variability, optical sensors typically have a relatively limited spectral sensitivity or variability, which can lead to inaccurate results when measurements over a relatively large portion of the spectrum are desired. Optical sensors can be optimized for specific wavelengths or ranges, which can result in incomplete or biased measurement, even more in environments with complex light sources.

Optical sensors may exhibit cross-sensitivity to environmental factors such as, for example, temperature, humidity, or electromagnetic interference. These external factors can interfere with the optical sensors capacity to measure optical properties at a satisfactory level.

The position and the orientation of optical sensors can impact the accuracy of the measurements. For example, shadows, obstructions, or reflective surfaces in the field of view of the optical sensors may affect the measurements, resulting in inconsistent or misleading data.

Existing optical sensors require regular maintenance to ensure optimal performances. Dust accumulation, moisture ingress, or physical damage can compromise the accuracy and reliability of the optical sensors over time, if not addressed promptly.

Addressing these drawbacks often requires careful selection of optical sensors, adequate installation and positioning, regular calibration and maintenance, and consideration of environmental factors that may affect sensor performances. Additionally, using complementary measurement techniques or integrating multiple sensors can help mitigating or at least reducing some of these challenges, to improve the overall quality of the measurements made with the optical sensors.

Combining a plurality of existing optical sensors can become an expensive approach, as it relies on advanced technologies, precision components, rigorous calibration processes, environmental considerations, specialized applications, compliance requirements and limited economies of scale. These factors collectively contribute to the higher pricing of existing sensors, in comparison with consumer electronics. Using multiple expensive sensors to mitigate the challenges mentioned earlier has a relatively considerable impact on the costs associated with the deployment or implementation of such technologies.

The techniques that will be herein described aim at addressing at least some of the drawbacks mentioned above (i.e., challenges around the calibration drift, the spectral response variability, the positioning and orientation of the optical sensors, and the maintenance requirements, while avoiding prohibitive costs).

The present description generally relates to techniques, including systems and methods, for monitoring illumination conditions produced by light sources. These techniques can be particularly useful in indoor environments but are not limited to this type of application.

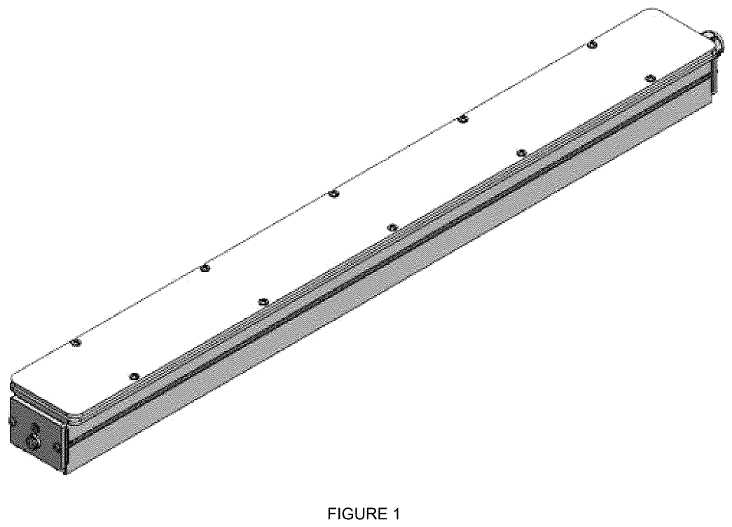

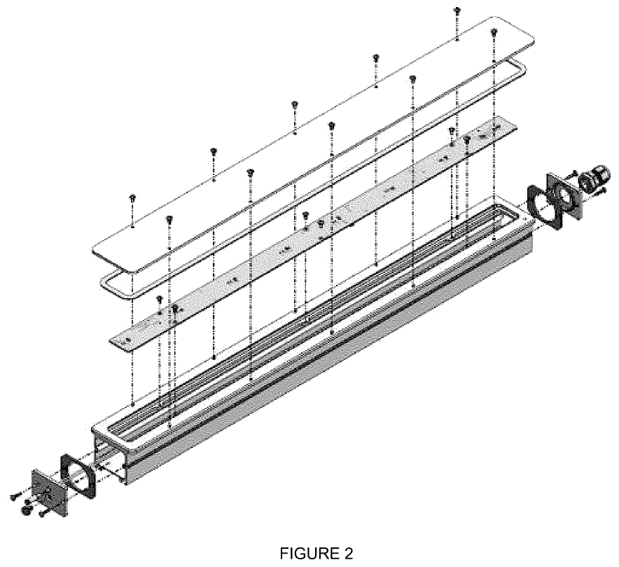

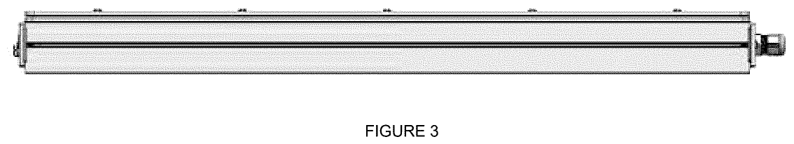

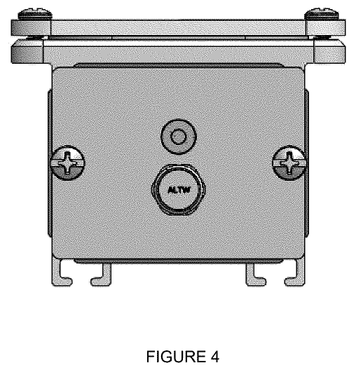

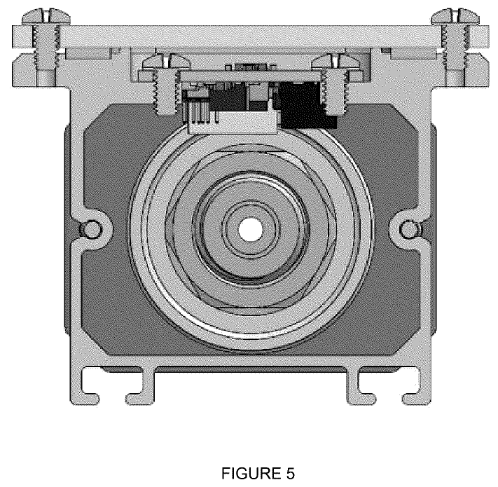

With reference to FIGS. 1 to 7, there is shown a system for monitoring illumination conditions produced by light sources. The light sources (not shown in the Figures) can be embodied by any types of light sources having been previously described. The system includes an elongated frame, at least two sensors (herein referred to as “sensors”) and a processor.

The elongated frame includes a plurality of sidewalls defining an internal volume. In the illustrated embodiments, the elongated frame is hollow, i.e., the internal volume is completely empty. In some embodiments, the internal volume may be at least partially empty.

The sensors are mechanically connected to the elongated frame. The mechanical connection between the sensors and the elongated frame may be direct or indirect. In some embodiments, the system further includes a support plate. The support plate has dimensions similar or slightly smaller to the dimensions of the elongated frame. The support plate is sized to be mechanically engaged with the elongated frame. The support plate can be inserted in the elongated frame, attached to the elongated frame, or engaged with a sliding mechanism to the elongated frame. In some embodiments, the sensors are mounted or attached to the support plate. In some embodiments, the sensors are directly connected to the elongated frame.

The sensors are oriented towards the light sources and are adapted to measure at least one optical property of the illumination conditions of the environment in which the system is placed. One example of the optical properties that can be measured by the sensors is the spectrum power distribution (SPD). Other optical properties can also be measured.

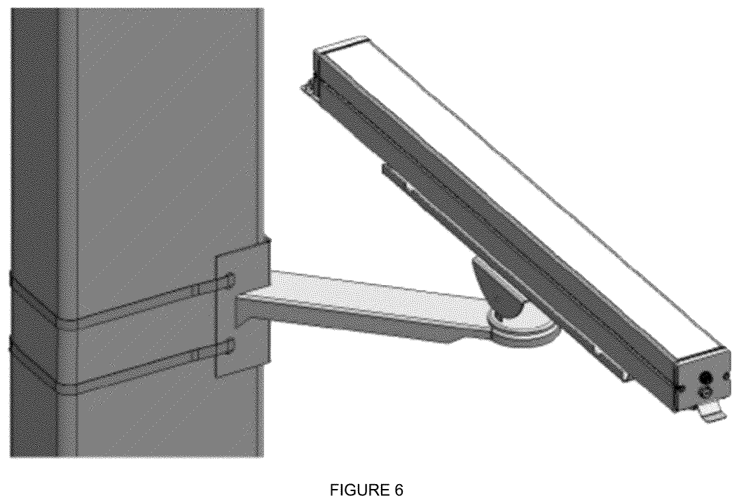

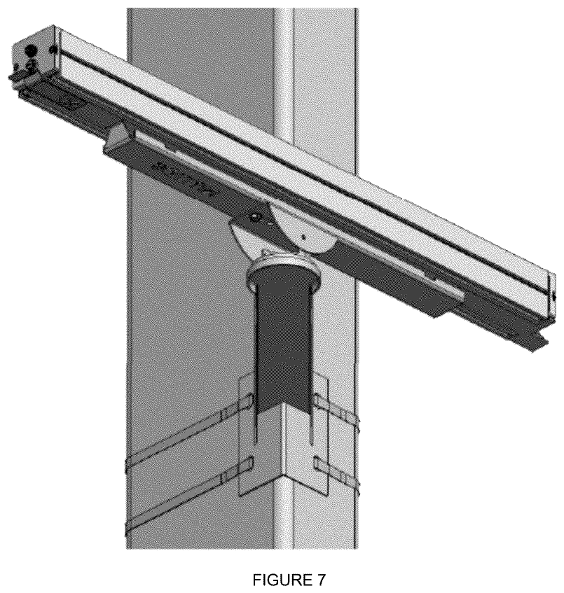

In some embodiments, the position and/or the orientation of the sensors is adjustable. In some embodiments, the system includes a levelling-assistance mechanism operatively connected to the elongated frame and/or the sensors. The levelling-assistance mechanism is configured to control a position or an orientation of the elongated frame, or the sensors, with respect to the light sources. A nonlimitative example of the levelling-assistance mechanism is illustrated in FIGS. 6 and 7. In some embodiments, the levelling-assistance mechanism includes an accelerometer. In some embodiments the levelling-assistance mechanism includes a gyroscope. In some embodiments, the levelling-assistance mechanism includes a feedback loop configured to detect and/or monitor the position or orientation of the elongated frame and/or the at least two sensors and provide an indication associated therewith.

In some embodiments, all the sensors are optical sensors. In some embodiments, different “classes” or “types” of sensors may be used. For example, and without being limitative, the sensors may be embodied by optical sensor(s), electrical sensor(s), electronic sensor(s), acoustic sensor(s), pressure sensor(s), temperature sensor(s), thermal sensor(s), motion sensor(s), sound sensor(s), image sensor(s), humidity sensor(s), proximity sensor(s), chemical sensor(s), biosensor(s), biochemical sensor(s), or any combinations thereof. It would have been readily understood that the type(s) of sensors included in the system depend on the targeted application and the relevant phenomenon to be characterized for this targeted application.

In some embodiments, the system includes more than two sensors. In some embodiments, the sensors are grouped or organized in an array of sensors. In some embodiments, the array of sensors is evenly distributed between two extremities of the elongated frame. The expression “evenly distributed”, as used in the context of the present disclosure, encompasses embodiments in which the array of sensors is spatially organized according to a pattern. The pattern may be periodic, semi-periodic, quasi-periodic or aperiodic. In some embodiments, the extremities are opposite and/or parallel sidewalls of the elongated frame. The sidewalls forming the extremities may be aligned with the length or the width of the elongated frame. An even distribution of the sensors can be useful to help at least reducing, mitigating or even eliminating the potentially negative effects or impacts of external factors on the measurements made by the sensors, such as the presence of shadows. In indoor environments, shadows can be momentarily, temporarily or permanently produced, under some circumstances, by structures or objects present in the environment, human beings, weather, and many other factors. Using an organized array of sensors helps in characterizing the impact of these factors on the measurements made with the sensors.

In some embodiments, the system includes a panel extending over the at least two sensors. The panel may extend over all the external surface of one sidewall of the elongated frame. In some embodiments, the panel is made from diffused glass. Other materials having similar properties could also be used. In some embodiments, the system includes a cleaning detection module, configured to automatically or semi-automatically determine when the panel should be cleaned, in order to avoid potentially negative impacts on the measurements made by the sensors. The cleaning process may be automatically or manually performed.

The processor is operatively connected to the sensors. The processor is configured to perform a series of steps. One step achieved by the processor is obtaining information associated with the at least one optical property measured by the sensors. Another step achieved by the processor is comparing the information to determine a presence or an absence of unexpected data. In presence of unexpected data, the processor is configured to determine an event potentially attributable to the presence of unexpected data and provide a correction factor to the at least one optical property measured by the sensors to obtain at least one corrected optical property representative of actual illumination conditions. In absence of unexpected data, the processor is configured to validate that the at least one optical property measured by the two sensors is representative of the actual illumination conditions.

In some embodiments, the system includes a calibration mechanism. The calibration mechanism includes at least one calibration emitter (simply referred to as the “calibration emitter”). In some embodiments, the calibration mechanism or at least a component thereof (e.g., the calibration emitter) is mechanically connected to the elongated frame. In some embodiments, the calibration emitter may be provided elsewhere than on the system. A nonlimitative example of such an embodiment would be positioning the calibration emitter(s) on the horticultural source. The calibration emitter is configured to emit a reference beam in a non-continuous regime (e.g., pulsed or chopped). The reference beam has reference properties. The calibration mechanism is configured to compare the reference properties measured by the sensors with calibration data representative of expected reference properties, and, upon identification of a difference between the reference properties and the calibration data, adjust the correction factor accordingly.

In some embodiments, the non-continuous regime includes emitting the reference beam at a predetermined interval for a predetermined duration. In some embodiments, the reference beam is emitted when the light sources are closed.

In some embodiments, the system or at least components thereof are powered by batteries.

In accordance with one aspect, there is provided a method for monitoring illumination conditions produced by light sources. The method includes a step of measuring at least one optical property of the illumination conditions with at least two sensors. The method includes a step of obtaining information associated with the at least one optical property measured by the at least two sensors. The method includes a step of comparing the information to determine a presence or an absence of unexpected data. In presence of unexpected data, the method includes a step of determining an event potentially attributable to the presence of unexpected data and providing a correction factor to the at least one optical property measured by the at least two sensors to obtain at least one corrected optical property representative of actual illumination conditions. In absence of unexpected data, the method includes a step of validating that the at least one optical property measured by the at least two sensors is representative of the actual illumination conditions.

In some embodiments, the method includes controlling, with a levelling-assistance mechanism, a position or an orientation of at least one of the elongated frame and the at least two sensors with respect to the light sources.

In some embodiments, the method includes calibrating the at least two sensors with a calibration mechanism, the calibration mechanism including at least one calibration emitter, the at least one calibration emitter being configured to emit a reference beam in a non-continuous regime, the reference beam having reference properties, the calibration mechanism being configured to compare the reference properties measured by the at least two sensors with calibration data representative of expected reference properties, and, upon identification of a difference between the reference properties and the calibration data, adjust the correction factor accordingly.

In accordance with another aspect of the present description, there is provided a non-transitory computer readable storage medium having stored thereon computer executable instructions that, when executed by a processor, cause the processor to perform the methods that have been previously described. The non-transitory computer storage medium can be integrated to the systems or assemblies that have been described in the present description. The non-transitory computer storage medium could otherwise be operatively connected with the systems or assemblies. In the present description, the terms “computer readable storage medium” and “computer readable memory” are intended to refer to a non-transitory and tangible computer product that can store and communicate executable instructions for the implementation of various steps of the method disclosed herein. The computer readable memory can be any computer data storage device or assembly of such devices, including random-access memory (RAM), dynamic RAM, read-only memory (ROM), magnetic storage devices such as hard disk drives, solid state drives, floppy disks and magnetic tape, optical storage devices such as compact discs (CDs or CDROMs), digital video discs (DVD) and Blu-Ray™ discs; flash drive memory, and/or other non-transitory memory technologies. A plurality of such storage devices may be provided, as can be understood by those skilled in the art. The computer readable memory may be associated with, coupled to, or included in a computer or processor configured to execute instructions contained in a computer program stored in the computer readable memory and relating to various functions associated with the computer.

### EXAMPLE

Now that different embodiments of the technology have been described, a nonlimitative example illustrating potential implementations of the techniques will be presented. It should be noted that this example serves an illustrative purpose only and should therefore not be considered limitative.

According to this example, there is provided a light spectrum measurement device for measuring light spectrum power distribution (SPD) for horticultural applications. The device may be used as a stand-alone measurement device or in connected mode, for instance in conjunction with a light rectification application such as the one described in US20220046773. The device has a linear factor designed to minimize the effect of shading. The device has a rugged design to resist to heat socks, humidity, dust, insects, fertilizers, insecticides, and cleaning products commonly found in greenhouse environments. The device includes a sensor array of at least two light sensors of the same type and model, positioned behind a diffused glass, that are normally oriented toward the light. In a preferred configuration, the light sensors are spectral sensors optimized for spectral reconstruction within visible spectrum (VIS) to near-infrared (NIR) range, 380 nm to 1000 nm wavelengths. In other configurations, the sensor array consists of PAR sensors, lux sensors, CRI sensors, UV sensors, or other types of light sensors. In one configuration, the device is levelled, and the sensors are oriented in an upward position toward the sky. The device may be equipped with an electronic leveling assistance mechanism consisting of an accelerometer or a gyroscope and a visual or auditive indication of the device position. Other sensors may be complementing the base spectrum sensors such as, for example, PAR sensors, lux sensors, CRI sensors, UV sensors, and many others. The use of multiple SPD sensors enables a more uniform reading of the light spectrum and enables detection of shadows by the underlying software. The device has a processing unit capable of acquiring data from individual sensors of the same types, combining that data, identifying anomalies such as the ones resulting from a moving sun shadow and combine the readings into a mor precise combined measurement. The device may be equipped with a display indicating device information such as combined SPD, presence of shadow detected, a score indicating how close to a desired SPD is measured light. The device may be equipped with wireless communication capabilities for integrating with other systems, such as Wi-Fi, LORA, Bluetooth SIG Mesh, or wired connectivity such as USB, Ethernet. The device may be equipped with fixed or removable batteries. Batteries may be using built-in solar panels, Ethernet PoE or USB. Over time, sensors precision can change, and they may need to be re-calibrated. This can negatively impact readings provided by the device. To help in managing this, the device is quipped with a mechanism to automatically self-calibrate. At least one calibration LED's is installed behind the glass, and/or at the glass edges, inside the enclosure. At preset intervals, during darkness, the calibration LED is lit for a short period of time. The difference between the expected and actual reading from the sensors is captured and saved for later use as a correction factor. LED bulbs are very susceptible to excessive heat or moisture, contributing to the speed of LED colors and intensity degradation. However, in that scenario, infrequent and momentaneous use of the calibration LED significantly reduces this phenomenon, resulting in a trustable stable reference point for calibration. Over time, bugs and dust deposits can accumulate over the glass surface of the device. This can negatively impact readings provided by the enclosed sensors. To help in managing this, the device is quipped with a mechanism to determine if the glass requires cleaning. The mechanism works by correlating information provided by external readings by individual sensors, over time, and control LEDs readings. If the correlation indicates that there may be presence of deposits, an audible signal is produced, a visual indicator is activated on the device, or a status is provided for access via the network connection.

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the present disclosure and appended claims.

The foregoing disclosure of specific embodiments is intended to be illustrative of the broad concepts comprehended by the invention.

1. A system for monitoring illumination conditions produced by light sources, the system comprising:
an elongated frame;
at least two sensors mechanically connected to the elongated frame and oriented towards the light sources, the at least two sensors being adapted to measure at least one optical property related to the illumination conditions; and
a processor operatively connected to the at least two sensors, the processor being configured to:
obtain information associated with the at least one optical property measured by the at least two sensors;
compare the information to determine a presence or an absence of unexpected data, such that:
in the presence of unexpected data, the processor is configured to determine an event potentially attributable to the presence of unexpected data and provide a correction factor to the at least one optical property measured by the at least two sensors to obtain at least one corrected optical property representative of actual illumination conditions; and
in the absence of unexpected data, the processor is configured to validate that the at least one optical property measured by the at least two sensors is representative of the actual illumination conditions.

2. The system of claim 1, further comprising a panel extending over the at least two sensors.

3. The system of claim 2, wherein the panel is made of diffused glass.

4. The system of claim 1, further comprising a levelling-assistance mechanism operatively connected to at least one of the elongated frame and the at least two sensors, the levelling-assistance mechanism being configured to control a position or an orientation of at least one of the elongated frame and the at least two sensors with respect to the light sources.

5. The system of claim 4, wherein the levelling-assistance mechanism comprises an accelerometer and/or a gyroscope.

6. The system of claim 4, wherein the levelling-assistance mechanism comprises a feedback loop configured to detect and/or monitor the position or orientation of the elongated frame and/or the at least two sensors and provide an indication associated therewith.

7. The system of claim 1, further comprising a calibration mechanism, the calibration mechanism comprising at least one calibration emitter, the at least one calibration emitter being configured to emit a reference beam in a non-continuous regime, the reference beam having reference properties, the calibration mechanism being configured to compare the reference properties measured by the at least two sensors with calibration data representative of expected reference properties, and, upon identification of a difference between the reference properties and the calibration data, adjust the correction factor accordingly.

8. The system of claim 7, wherein the non-continuous regime comprises emitting the reference beam at a predetermined interval for a predetermined duration.

9. The system of claim 8, wherein the reference beam is emitted when the light sources are closed.

10. The system of claim 1, wherein each of the at least two sensors is a spectral sensor configured to detect wavelengths in a range extending from about 380 nm to about 1000 nm.

11. The system of claim 1, wherein the at least one optical property comprises a spectrum power distribution (SPD) of the illumination conditions.

12. The system of claim 1, wherein the at least two sensors is an array of sensors evenly distributed between two extremities of the elongated frame.

13. A method for monitoring illumination conditions produced by light sources, the method comprising:
measuring at least one optical property related to the illumination conditions with at least two sensors;
obtaining information associated with the at least one optical property measured by the at least two sensors; and
comparing the information to determine a presence or an absence of unexpected data, such that:
in the presence of unexpected data, determining an event potentially attributable to the presence of unexpected data and providing a correction factor to the at least one optical property measured by the at least two sensors to obtain at least one corrected optical property representative of actual illumination conditions; and
in the absence of unexpected data, validating that the at least one optical property measured by the at least two sensors is representative of the actual illumination conditions.

14. The method of claim 13, further comprising controlling, with a levelling-assistance mechanism, a position or an orientation of at least one of the elongated frame and the at least two sensors with respect to the light sources.

15. The method of claim 14, further comprising controlling, with the levelling-assistance mechanism, an orientation of at least one of the elongated frame and the at least two sensors with respect to the light sources.

16. The method of claim 15, further comprising monitoring the position or the orientation of the elongated frame and/or the at least two sensors.

17. The method of claim 13, further comprising calibrating the at least two sensors with a calibration mechanism, the calibration mechanism comprising at least one calibration emitter, the at least one calibration emitter being configured to emit a reference beam in a non-continuous regime, the reference beam having reference properties, the calibration mechanism being configured to compare the reference properties measured by the at least two sensors with calibration data representative of expected reference properties, and, upon identification of a difference between the reference properties and the calibration data, adjust the correction factor accordingly.

18. The method of claim 17, wherein the non-continuous regime comprises emitting the reference beam at a predetermined interval for a predetermined duration.

19. The method of claim 18, wherein said emitting the reference beam is carried out when the light sources are closed.

20. A non-transitory computer readable storage medium having stored thereon computer executable instructions that, when executed by a processor, cause the processor to perform the method of claim 13.
